(19) United States
(12) Patent Application Publication
(10) Pub. No.: US 2014/0029096 A1
(43) Pub. Date: Jan. 30, 2014

(54) 3D Polarized Eyewear

(71) Applicants: David Kessler, Rochester, NY (US); Pasquale Matera, Plainview, NY (US)

(72) Inventors: David Kessler, Rochester, NY (US); Pasquale Matera, Plainview, NY (US)

(73) Assignee: SOL-GRID, LLC, Rochester, NY (US)

(21) Appl. No.: 13/561,111

(22) Filed: Jul. 30, 2012

(51) Int. Cl. G02B 27/26

(52) U.S. Cl. 359/465

(57) ABSTRACT

An article of eyewear for viewing a 3D display has at least one lens, wherein the at least one lens has a substrate lens material that is transparent to visible light and has a curved surface. A circular polarizer is formed on the substrate lens material and has a linear polarizer with a polarization axis and a quarter wave plate with a retardation axis that is inclined at substantially 45 degrees from the polarization axis along the curved surface. Either or both of the linear polarizer and the quarter wave plate are formed as sub-wavelength elongated structure devices.

### FIELD OF THE INVENTION

This invention generally relates to apparatus and methods for viewing stereoscopic images and more particularly to eyewear for viewing stereoscopic displays that separate left-eye from right-eye images using polarization.

### BACKGROUND OF THE INVENTION

Stereoscopic projection is a growing area of particular interest for the entertainment industry. Presentation of three-dimensional (3D) images or perceived stereoscopic content affords the viewer an enhanced visual experience, in the home theater setting or in larger venues such as movie theaters. Stereoscopic systems have been implemented using film, in which two sets of films and projectors simultaneously project orthogonal polarizations, one for each eye, termed a “left-eye image” and a “right-eye image” in the present disclosure. With digital projection and display, more options for image presentation are available, so that even a single projector or display device can be used to provide separate left- and right-eye imaging paths. Audience members wear corresponding orthogonally polarized glasses that block one polarized light image for each eye while transmitting the orthogonal polarized light image.

Polarized light can be represented as the sum of two orthogonal linear components. FIGS. 1A and 1B show how the phase relationship of these components affects light polarization for linear and circular polarization for light of wavelength λ, respectively. A phase delay φ=0 between x- and y-components, represented as vectors Eₓ and E_{y}, respectively, yields a resultant electric field vector Eₛᵤₘ that oscillates about a line oriented at 45°, providing a linear polarization 200 as shown in FIG. 1A. If the phase delay φ=+/−π/2, then Eₛᵤₘ maintains constant magnitude but rotates about the origin, providing a circular polarization 210, as shown in FIG. 1B. A phase delay φ=+π/2 provides right circular polarization; a phase delay φ=−π/2 provides left circular polarization, orthogonal to the right circular polarization at each instant. An arbitrary phase delay (for example, φ=0.35·2π) yields a vector Eₛᵤₘ with varying magnitude and position, resulting in elliptical polarization.

Linear polarization was used for left- and right-eye image separation in some early 3D imaging systems. However, the use of linearly polarized light is generally disadvantageous for this purpose, since the viewer's head must remain at the same angle to avoid cross-talk, a condition in which some portion of light intended for the left-eye image goes to the right eye and light intended for the right-eye image goes to the left eye. To avoid this problem, most stereoscopic imaging apparatus that employ polarization to separate left- and right-eye image content use circular, rather than linear, polarization. With circular polarization, cross-talk can be significantly reduced, since there is no fixed polarization axis relative to the display surface. As shown from the viewer's perspective in FIG. 2, for a pair of viewing glasses 220, the circular polarization for the left-eye image, light directed through a lens L1, provides rotation in the opposite direction to the circular polarization for the right-eye image, directed through a lens R1.

A circular polarizer can be formed by combining a linear polarizer with a retarder, such as a quarter wave plate (QWP). As shown in FIG. 3, a QWP, when its axis, or polarization azimuth, has the proper orientation with respect to the polarization axis of the polarizer, provides the needed π/2 phase delay of one component of the periodic light signal that transforms linearly polarized light 200 to circularly polarized light 210. To transform linearly polarized light 200 to right circular polarized light 210, the QWP transmission axis is 45 degrees in one direction from the polarized light axis. To transform linearly polarized light 200 to left circular polarized light 210, the QWP transmission axis is 45 degrees in the opposite direction from the polarized light axis.

The polarizers that are most widely available are of the linear type that employ a type of form birefringence at the molecular level. Conventional polarizing material is formed of a thin sheet of polymer material (typically polyvinyl acetate, PVA) impregnated with iodine molecules. The sheet is stretched to align the iodine molecules in order to form a polarizing structure at the molecular level. Treatment with various dyes and lamination then form the stretched sheet into a single-axis polarizer. This type of polarizer has its polarization axis determined according to the direction in which it has been stretched. Due to their inherent tint, imperfections in fabrication, and other factors, polarizers of this type, although they may serve well in sunglasses and other optical devices, are generally not well suited for use in 3D imaging glasses. One problem in fabrication of this type of polarizer is in controlling the orientation of the polarization axis, when the polarized material is curved to form eyeglasses.

FIG. 4A shows the conventional practice where polarizing glasses have a preferred polarization axis A1 that is generally horizontal. Thus, conventional 3D glasses have the QWP retardation axis A2 and A3, where A2 is at +45 degrees from the polarization axis A1 for one eye and axis A3 at −45 degrees from the polarization axis A1 for the other eye. (This assumes that right circular polarization goes to the right eye and left circular polarization to the left eye; the opposite arrangement of QWP axis would apply for the opposite polarization sense.) An alternate arrangement, as shown in FIG. 4B, is to orient the QWP retardation axis A2 along the horizontal and to orient polarization axes A5 and A6 at +/−45 degrees accordingly for each eye.

These fabrication restrictions for polarization axes and conventional practices for QWP axis alignment complicate the manufacture of 3D polarization glasses and drive up the cost. Given the inherent difficulties and added steps that would be required for determining the polarization axis of the stretched materials that are conventionally used and changing axes appropriately for each pair of viewing glasses, there may be few options for mass-produced 3D viewing eyewear using conventional fabrication methods.

With the growing popularity of stereoscopic or 3D imaging, there is growing interest in apparatus and methods that provide improved circular polarizers that reduce cross-talk, provide high light levels, and can be produced at low cost.

### SUMMARY OF THE INVENTION

It is an object of the present invention to address the need for viewing glasses for stereoscopic imaging applications. With this object in mind, the present invention provides an article of eyewear for viewing a 3D display having at least one lens, wherein the at least one lens comprises:
a substrate lens material that is transparent to visible light and has a curved surface; and
a circular polarizer formed on the substrate lens material, wherein the circular polarizer comprises:
   (i) a linear polarizer having a polarization axis; and
   (ii) a quarter wave plate having a retardation axis that is inclined at substantially 45 degrees from the polarization axis along the curved surface,
wherein either or both of the linear polarizer and the quarter wave plate are formed as sub-wavelength elongated structure devices.

It is a feature of the present invention that it uses a linear polarizer with added spatial polarization azimuth control to provide viewing glasses that allow improved differentiation of left- and right-eye imaging for stereoscopic viewing. Advantageously, embodiments of the present invention improve existing fabrication processes and provide viewing glasses that allow increased amounts of light and reduced cross-talk over existing solutions.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1A is a schematic diagram that shows the phase relationship for linearly polarized light.

FIG. 1B is a schematic diagram that shows the phase relationship for circularly polarized light.

FIG. 2 is a schematic diagram that shows polarization properties of 3D viewing glasses that use circular polarization to separate left- and right-eye images.

FIG. 3 is a schematic diagram that shows the function of a quarter wave plate for transforming linearly polarized to circularly polarized light.

FIG. 4A is a schematic diagram showing conventional 3D viewing glasses with one orientation of polarization to retardation axes.

FIG. 4B is a schematic diagram showing conventional 3D viewing glasses with an alternate orientation of polarization to retardation axes.

FIG. 5A is a schematic diagram showing the parts of a pair of 3D viewing glasses.

FIG. 5B is a schematic diagram that shows the light path through the parts of the 3D viewing glasses shown in FIG. 5A.

FIG. 6 is a schematic diagram that shows basic principles of wire grid polarizer operation.

FIG. 7A is a schematic diagram that shows 3D viewing glasses with a consistent polarization axis.

FIG. 7B is a schematic diagram that shows 3D viewing glasses with a variable polarization axis, varying over different regions of the lens.

FIG. 8A is a diagram showing distortion of polarization and retardation axes.

FIG. 8B is a process diagram that shows how a circular polarizer can be formed from linear polarizer and quarter wave plate components.

FIG. 8C is a perspective diagram that shows a quarter wave plate formed using sub-wavelength elongated structures.

FIG. 9 is a perspective diagram showing cholesteric polarizer behavior.

FIG. 10 is a cross-sectional diagram showing a circular polarizer on a non-corrected substrate surface.

FIG. 11 is a cross-sectional diagram showing a circular polarizer on a corrected substrate surface.

FIG. 12 is a cross-sectional diagram showing a circular polarizer on a corrected substrate surface.

FIG. 13 is a cross-sectional diagram showing a circular polarizer with quarter wave plate and linear polarizer components formed on opposite surfaces of the substrate.

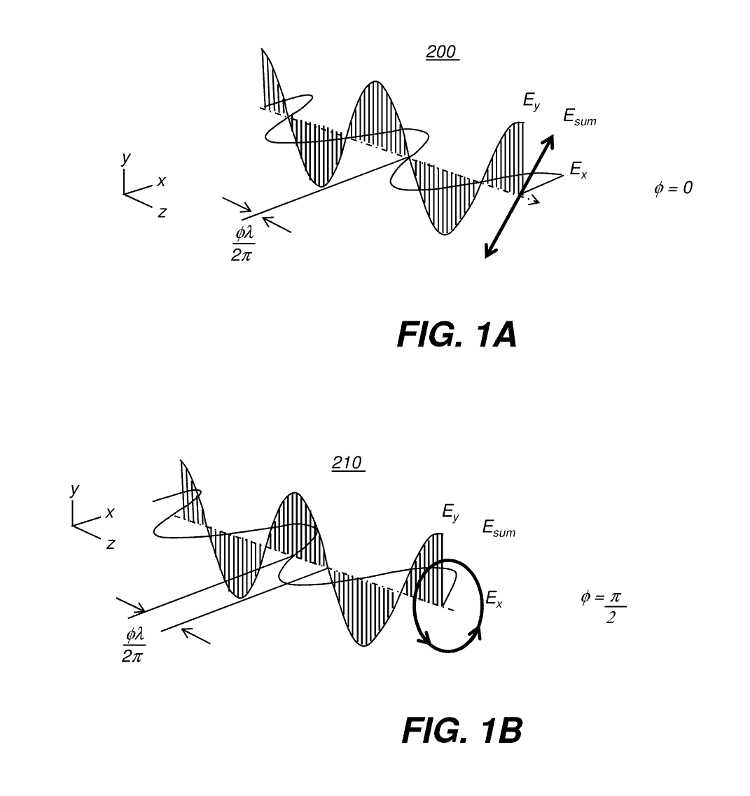

### DETAILED DESCRIPTION OF THE INVENTION

Elements not specifically shown or described may take various forms well known to those skilled in the art. Figures shown and described herein are provided in order to illustrate key principles of operation and component relationships along their respective optical paths or fabrication techniques according to the present invention and are not drawn with intent to show actual size or scale. Some exaggeration may be necessary in order to emphasize basic structural relationships or principles of operation.

In the context of the present disclosure, the term “display surface” relates to any type of display surface or device that provides stereoscopic or 3D image content in which light for each of the left-eye and right-eye image content is provided having circular polarization. The respective image content for each eye is of opposite circular polarization. Thus, for example, where right circular polarization is used for the right-eye image, left circular polarization is used for the left-eye image. The term “vertex of the lens” refers to the intersection point of the optical axis of light from the display surface to the eyeglass lens when the viewer looks toward the display surface.

In the context of the present disclosure, the term “complex index of refraction” applies where the index of refraction for a material contains both a real component designated commonly as n and a significant imaginary (−i) component, commonly designated as k. Imaginary component k can be considered to be significant where the ratio of k to n satisfies:

$$\frac{k}{n } \geq 0.2$$

For example, metallic aluminum has a complex index of refraction, with its imaginary part k given by k=6.69 and its real part n, given by n=0.96 at wavelength of 500 nm. By contrast, materials for which the above ratio of k/n is less than 0.2 would not be considered to be materials having a complex index of refraction and are considered to have “predominantly real” indices of refraction. Glass and polycarbonate have indices of refraction that are predominantly real; for these materials, the above ratio of k/n is less than 0.2. The materials used as a lens substrate in embodiments of the present invention are materials having predominantly real indices of refraction, for example.

In the context of the present disclosure, the term “deposited” refers to any suitable method for applying one material against another and includes practices such as coating, sputtering, forming by growing, chemical vapor deposition, printing, nano-printing, adhesion, electro-plating or electroless plating, oxidation, evaporation, sublimation, plasma deposition, anodization, anodic deposition, molecular beam deposition, atomic layer deposition, or photo deposition, for example. A substrate transparent to visible light transmits at least 70% of the visible light.

The background section described the conventional linear polarizer that is formed from stretched film that operates by aligned strings of iodine molecules. Another type of linear polarizer is formed by deposition of a material having a complex index of refraction onto a transparent substrate, wherein the deposited material has a pattern of elongated structures of sub-wavelength dimensions. Polarizers of this type are called wire grid polarizers. Their fabrication and use for eyeglasses are described in detail, for example, in commonly assigned U.S. Pat. No. 7,771,045 entitled “Polarized Eyewear” to Matera et al., incorporated herein by reference in its entirety. These devices are a type of Sub-Wavelength Elongated Structure (SWES) device, in which the material used for the elongated structures has a complex index of refraction, with both real and imaginary components.

Historically, wire grid polarizers were first developed for polarization of radio waves, then as sub-wavelength gratings for use as polarizers at infrared and higher wavelengths, well above the visible. More recently, advances in photolithography, interference lithography, and other high-resolution fabrication techniques have expanded the usability of wire grid polarizers to visible wavelengths.

Wire grid polarizers are a type of photonic crystal, wherein a photonic crystal is the broader category of sub-microscopic, periodic dielectric structures that possess spectral gaps (stop bands) for electromagnetic waves, analogous to energy bands and gaps in semiconductors. A few types of photonic crystal are formed in nature; other types are fabricated, such as one-dimensional photonic crystals formed by stacking multiple dielectric layers, such as a Bragg mirror for example. As fabricated, photonic crystals contain regularly spaced regions having alternately higher and lower dielectric constants. Photons, exhibiting wave behavior, may or may not propagate through this structure, depending on factors such as wavelength, spacing between layers, structures, or features, and relative indices of refraction. Wire grid polarizers themselves operate according to principles of structured birefringence, also termed “form” or “formed” birefringence. The wire grid polarizer is formed as an array of elongated structures or elongated elements, such as fine parallel metallic wires, that are arranged in a plane at a suitable angle to the incident beam. Advantageously, the wire grid arrangement, with appropriate materials, can also be used to form a type of retarder such as a quarter wave plate QWP.

Embodiments of the present invention are directed to improved 3D viewing glasses with curved lenses and methods for their fabrication. The inventors have recognized that conventional methods for forming circular polarizers by combining a linear polarizer with a QWP can be cumbersome and costly, and often result in disappointing performance, with excessive crosstalk for the viewer. Because it can be difficult to determine how the polarization axes extend and to control how the polarization axes align in viewer glass presentation, conventional methods are performance-constrained. Apparatus and methods of the present invention make it possible to provide 3D viewing glasses that use circular polarization, with improved performance and significantly relaxed requirements for axis alignment relative to the structure of the viewing glasses themselves.

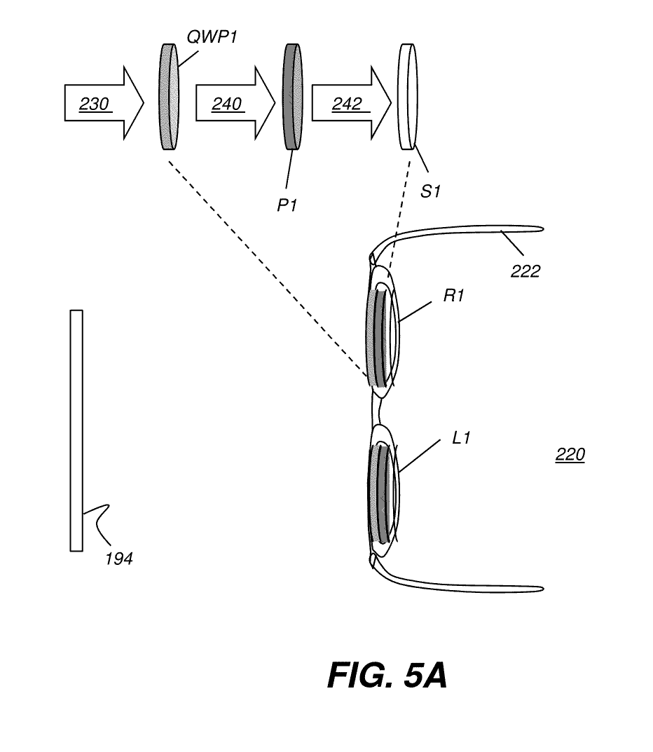

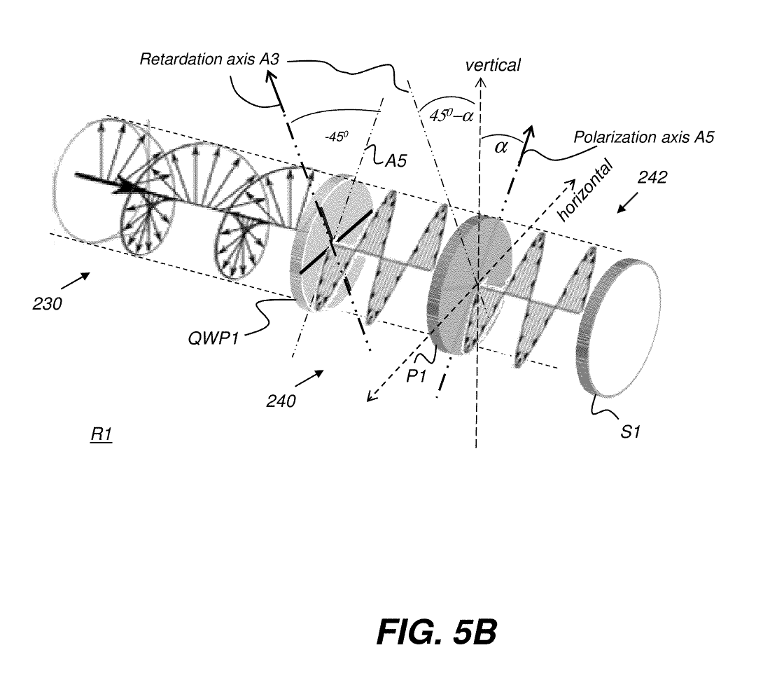

FIG. 5A is a schematic view that shows how lens R1 is formed for 3D viewing glasses 220 in a frame 222. FIG. 5B shows the behavior of the light at lens R1 in schematic form. A quarter wave plate QWP1 receives, from a display surface 194, incident light 230 that includes both left-eye and right-eye content and is circularly polarized. Retarder QWP1 transforms the light to linearly polarized light 240. QWP1 has a retardation axis A3 that is at 45 degrees from a polarization axis A5 of a polarizer P1. Polarizer P1 then transmits light for the right eye image 242 through lens substrate S1 and reflects the left-eye image content. An angle α indicates the orientation of axes with respect to a vertical. Left eye lens L1 works in similar fashion for light with orthogonal polarization.

According to an embodiment of the present invention, polarizer P1 is a conventional stretched PVA/iodine sheet. QWP1 is a conventional stretched polymeric retarder. LP1 and QWP1 are thermo-formed to conform to the surface of lens substrate S1. Unlike conventional viewing glass lenses, the polarization axis of polarizer P1 is not defined with respect to frame 222. A substantially +45 degree relationship between the polarization axis of polarizer P1 and the retardation axis of QWP1 is maintained for one of the eyes (for the right-eye image, for example). A substantially −45 degree relationship between the polarization axis of the polarizer and the retardation axis of the quarter wave plate is similarly maintained for the other (left) eye. By substantially +/−45 degrees is meant that deviation from this angular relationship between axes over a particular area of the lens is less than +/−5 degrees, with improved results as this deviation in angular difference is reduced to near or below +/−2 degrees and best results obtained when the angle between the retardation axis and polarization axis is 45 degrees with no more than about +/−1 degree tolerance.

According to an alternate embodiment of the present invention, polarizer P1 is a wire grid polarizer. The wire grid polarizer, a type of SWES device, provides the advantage of control of the polarization axis over arbitrarily small areas or regions along the polarizer surface.

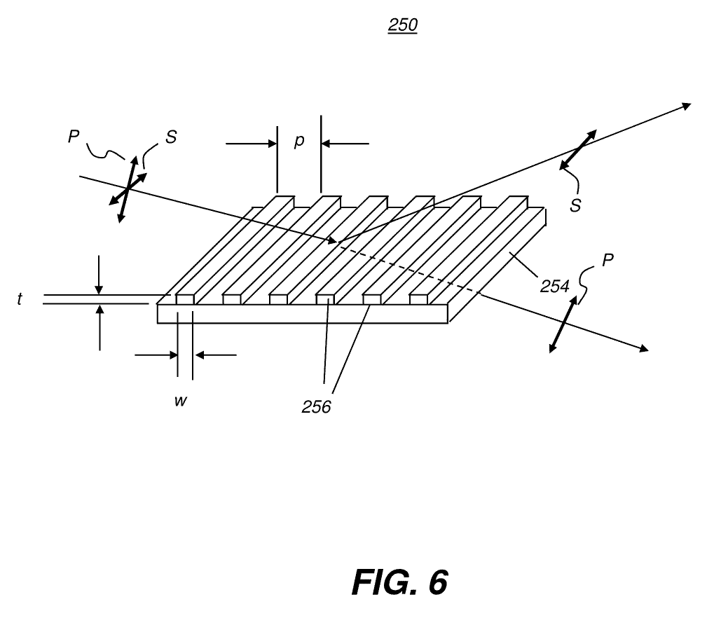

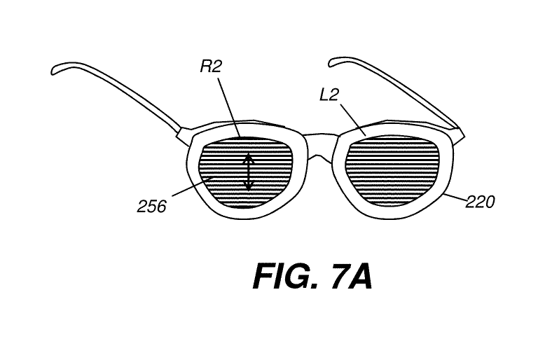

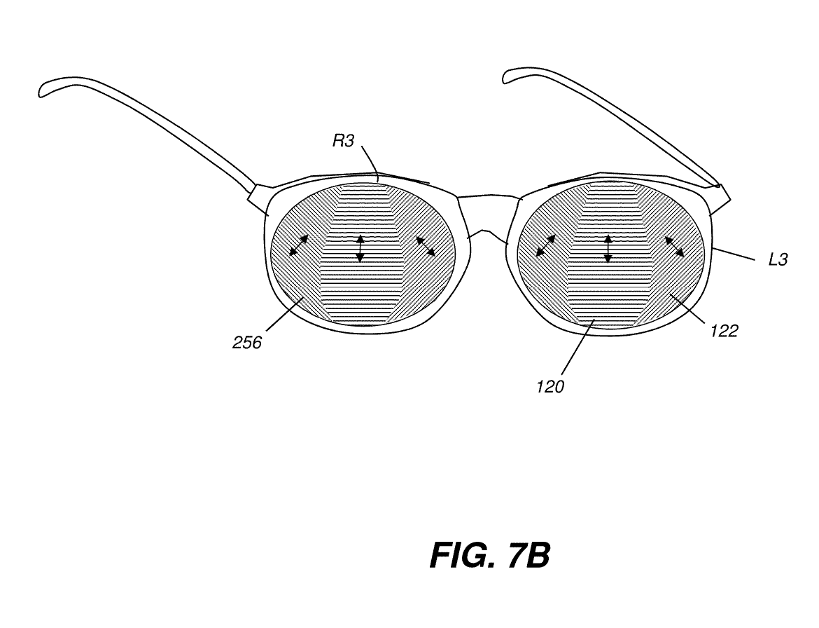

The advantages of a wire grid polarizer can be more readily appreciated by considering its overall structure and operation. Referring to FIG. 6, the behavior of a wire grid polarizer 250 is shown schematically over a small section of this type of device. Unpolarized light, shown entering at left, is incident on wire grid polarizer 250 and has both s- and p-polarization. Light having s-polarization, with a polarization axis that is parallel to sub-wavelength elongated structures 256, is reflected from the surface of wire grid polarizer 30. Light having the orthogonal polarization, shown as p-polarization in FIG. 6, is transmitted through a transparent substrate 254. With the wire grid polarizer, the direction of structures 256 within an area determines the corresponding polarization axis over that area. The polarization axis is orthogonal to the length direction in which structures 256 extend. Thus, unlike the conventional PVA/iodine stretched sheet polarizer, the wire grid polarizer allows accurate determination of polarization axis direction. Moreover, the wire grid polarizer can be formed to provide different polarization axes over different portions of the lens. Referring to FIG. 7A, lenses L2 and R2 have uniform elongated structures 256 in a generally horizontal direction and thus provide the same polarization axis across each lens surface. Referring to FIG. 7B, however, lenses L3 and R3 have areas in which elongated structures 256 extend in slightly different directions, providing a more complex pattern for polarization axes. To provide a linear polarizer, adjacent structures 256 are piecewise parallel over at least some length along the lens surface, as shown over a region 120 across the middle of lens L3 in FIG. 7B. By comparison, a second region 122 also has its adjacent structures 256 arranged in piecewise parallel manner over at least some length along the lens surface, but at a different orientation than over region 120. With either the uniform pattern across the lens shown in FIG. 7A or a series of patterns as shown in FIG. 7B, right- and left-circular polarizers can be formed for 3D viewing glasses with proper orientation of the QWP relative to the orientation of the polarization axis of the linear polarizer.

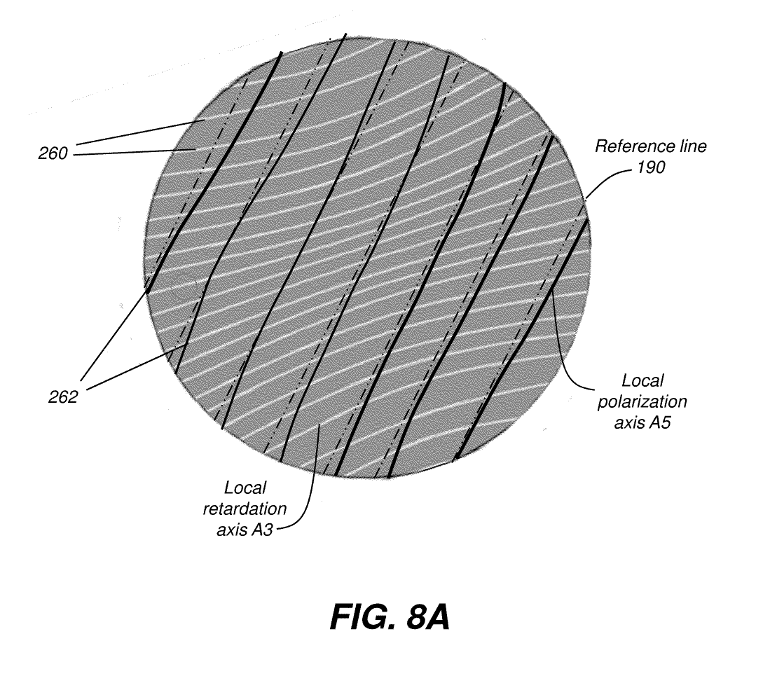

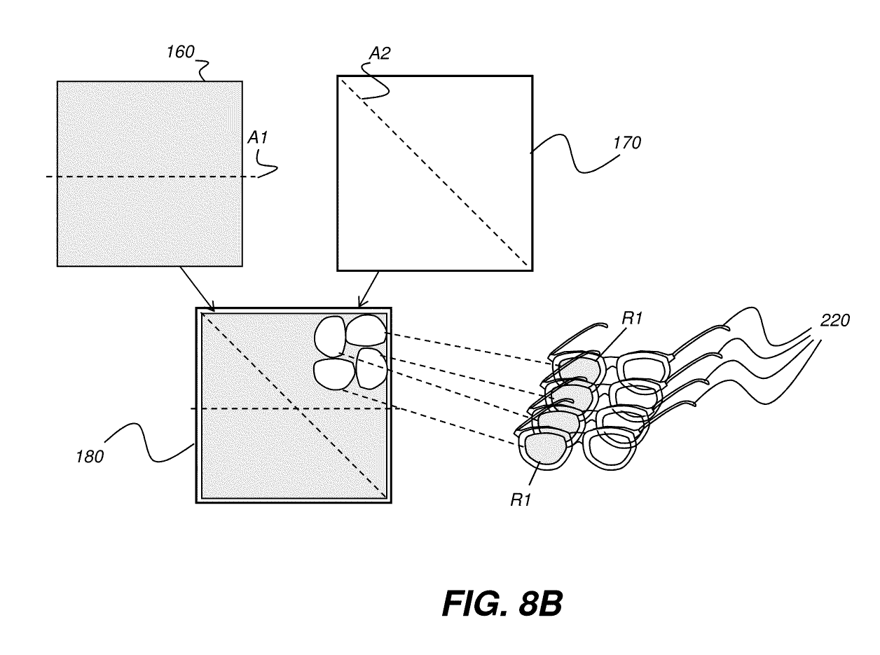

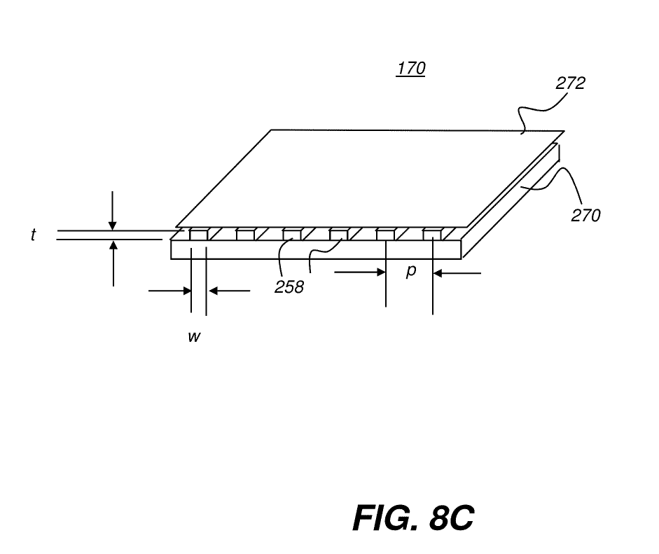

It is instructive to emphasize that the performance of the circular polarizer depends, in large part, on how well the relative axes of the combined linear polarizer and its QWP are matched, at the proper orientation angle. The distortion map of FIG. 8A shows in more detail how the degree of freedom in local control of the polarization axis direction, provided using SWES devices, can be used to improve performance of the circular polarizer. Lighter lines 260 indicate the local retardation axis A3 of a conventional QWP made from stretched polymer. A dashed reference line 190 indicates an undistorted polarization axis for the linear polarizer, such as can be obtained using conventional polarizer design approaches, without correction to compensate for irregularities in QWP response. Black lines 262 indicate the corresponding corrected polarization axis for the corresponding linear polarizer formed using wire grid construction.

It is possible to measure and determine the local retardation axis pattern for a conventional stretched-sheet retarder when it is applied to a lens with a specified curvature (or in optical industry terminology, having a specified “base number”). Utilities available for this measurement include, for example, the ELDIM EZ Contrast system made by ELDIM, Saint Clair, France. Once this pattern is determined, the map showing orientation of retardation axes 260 is used to derive the map showing the preferred orientation for polarization axes 262. In terms of the mapping of FIG. 8A, the derivation for polarization axes is relatively simple, since lines 262 are required to be oriented at 45 degrees relative to lines 260 at any point on the map. The wire grid polarizer can then be fabricated with its polarization axes 260 arranged per the map of lines representing axes 262. When this is done, the polarization and retardation axes along any small section of the lens can be accurately aligned at +/−45 degrees to each other. According to an embodiment of the present invention, a mapping of the QWP retardation axes is used as a reference when fabricating a wire grid polarizer, so that the two can be suitably matched to provide the needed circular polarizer. The map of the QWP axes is digitized, allowing the use of a software-controlled utility to generate the compensating wire grid polarizer pattern.

FIG. 8B shows fabrication steps for forming a circular polarizer CP 180 by overlaying a linear polarizer 160 having polarization axis A1 with QWP 170 having retardation axis A2. Once the respective axes of polarizer 160 and QWP 170 are correctly aligned, the circular polarizer 180 that results can be used in any orientation. Thus, the resulting composition of circular polarizer 180 can be cut or edged in a number of ways, allowing a pattern of cuts that minimizes waste for 3D viewing glass fabrication. The example of FIG. 8B shows right eye lenses R1 that have been cut out from circular polarizer 180 at different angles. Thermoforming or other steps for providing curvature are not shown.

According to an alternate embodiment of the present invention, the QWP 170 is also formed from Sub-Wavelength Elongated Structures (SWES). QWP structures that are considered to be sub-wavelength elongated structure devices are formed from materials having a predominantly real index of refraction, such as glass or polycarbonate, with retardation caused by structured birefringence. With reference to description given earlier, the ratio of imaginary to real components of the index of refraction is below 0.2 for materials used to form sub-wavelength elongated structures for a QWP. For materials that form SWES for the linear polarizer, however, the ratio of imaginary to real components of the index of refraction is at or above 0.2 as noted earlier.

FIG. 8C shows a greatly enlarged view of a small portion of QWP 170 formed according to an embodiment of the present invention, formed from elongated structures 258 sandwiched between a base 270 and a cap 272. Elongated structures 258 have a given pitch p, thickness t, and width w. Fabrication of these retarders is known and taught, for example, in U.S. Pat. No. 7,050,233 to Nikolov et al. and entitled “Precision Phase Retardation Devices and Method of Making Same” that also describes forming a retarder using sub wavelength structures with spatially variable axis direction. For this embodiment, then, viewing glasses have lenses with two types of Sub-Wavelength Elongated Structure (SWES). For the linear polarizer (P1 in FIG. 5B), the deposited material for SWES has a complex index of refraction, with real and imaginary vector components. For the quarter wave plate QWP1, the deposited material for SWES has a simple index of refraction, having only an index of refraction with real vector components.

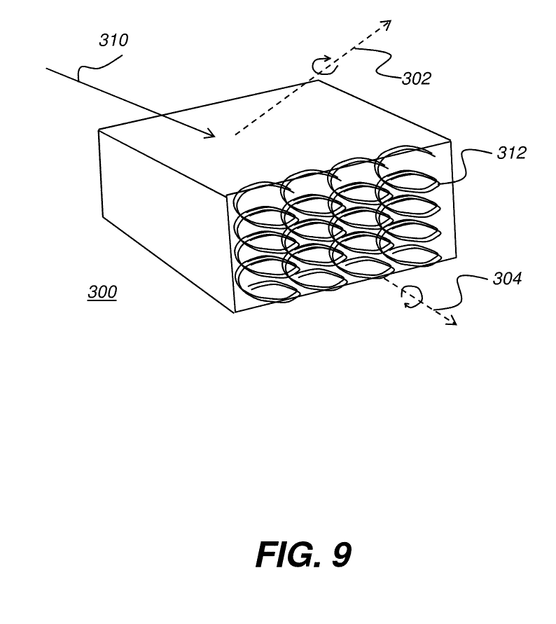

According to yet another embodiment of the present invention, a curved cholesteric polarizer CP (or CCP) is used instead of the QWP+LP composite. The perspective view of FIG. 9 shows a schematic diagram of a conventional cholesteric reflective polarizer 300, such as that described in U.S. Pat. No. 6,607,677 to Buchecker et al. and entitled “Optically Active Compounds”. As shown schematically in FIG. 9, the molecular structure of the curved cholesteric polarizer, shown as a molecular structure 312, upon receiving incident non-polarized light 310 reflects left circularly polarized light 302 and transmits right circularly polarized light 304.

According to an embodiment of the present invention, the CCP material can be curved to conform to the lens substrate. There is no need for aligning the CCP to a specific angle about the optical axis.

### Fabrication

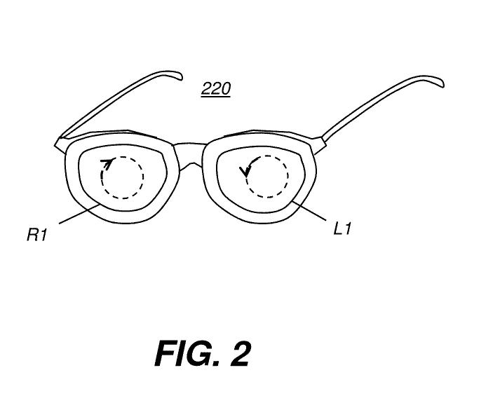

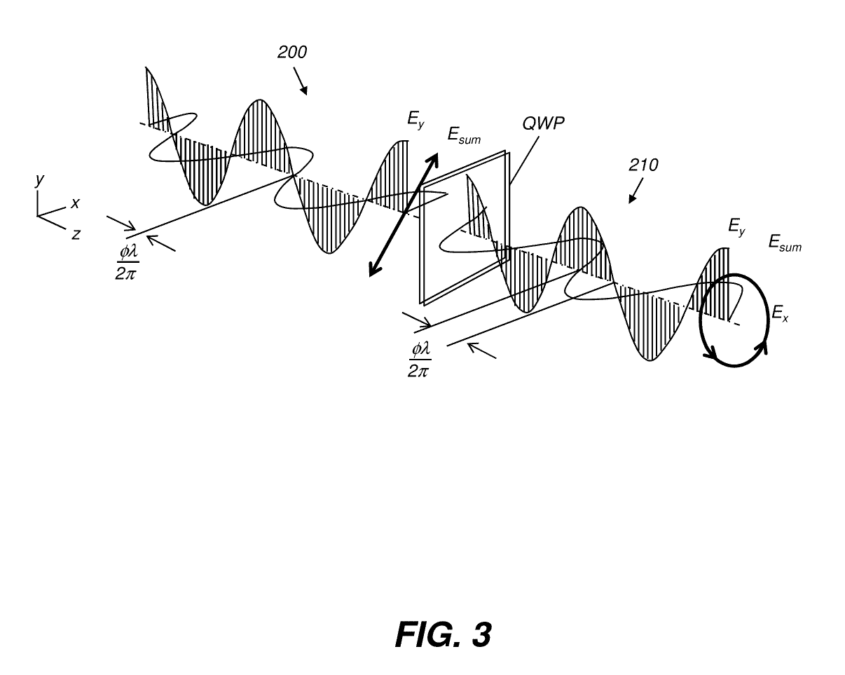

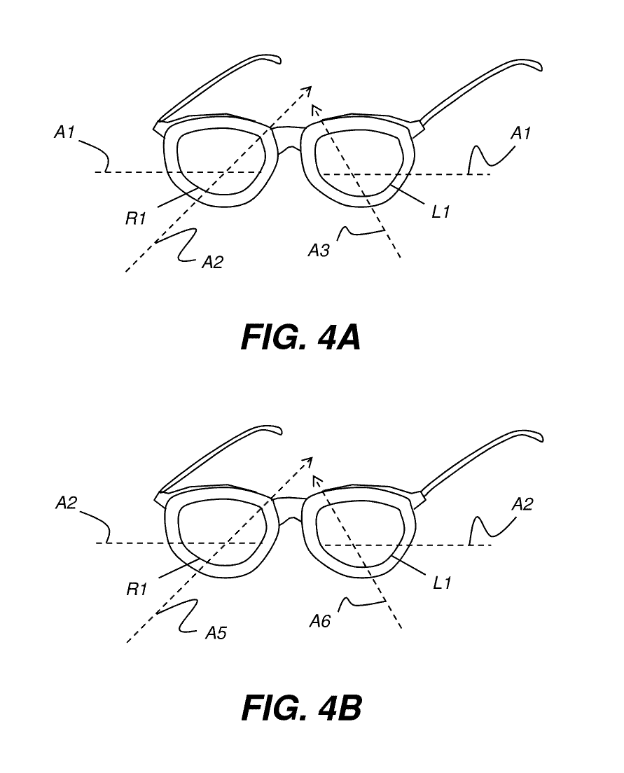

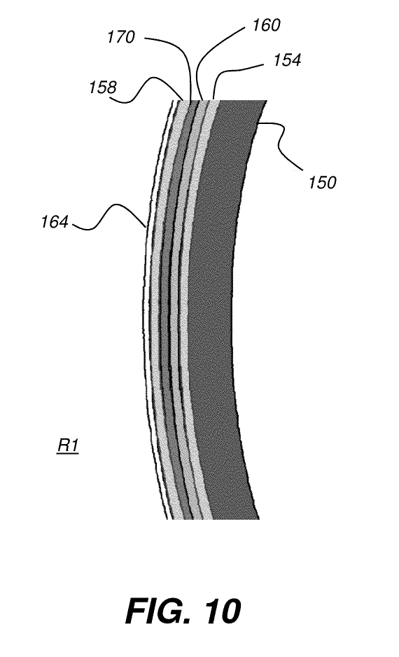

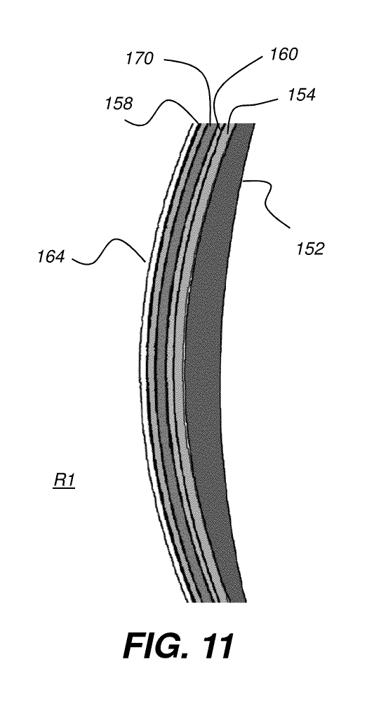

There are a number of options for fabrication of lenses R1 and L1 for 3D viewing glasses 220 as shown in FIG. 2. The cross sectional view of FIG. 10 shows components of one such lens, shown as lens R1, formed on a non-corrected lens substrate 150. A QWP 170 and a polarizer 160 are sandwiched between laminate substrates 154 and 158. A protective coating 164 is applied on the surface of the lens. The cross-sectional view of FIG. 11 shows this lens composition on a corrected lens substrate 152.

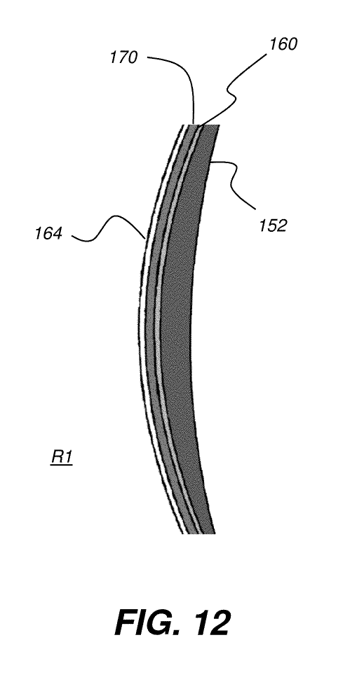

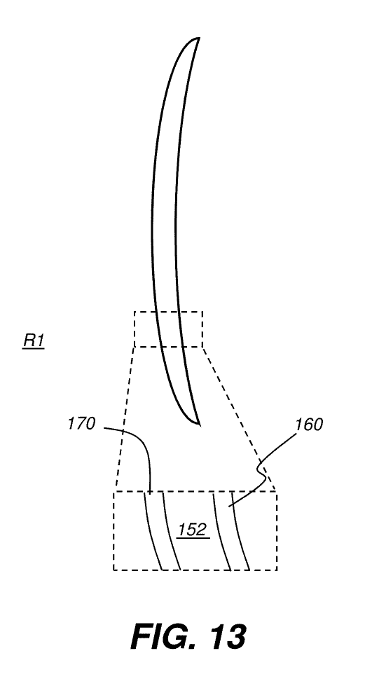

The cross sectional view of FIG. 12 shows an alternate embodiment that does not use the laminate layers, but applies polarizer 160 directly to the surface of corrected lens substrate 152. The same lens composition can be used on a non-corrected lens substrate 150.

One or more of the layers shown in FIGS. 9-12 can be on either the convex or concave (inner) side of the lens. As shown in enlarged cross-section in the example of FIG. 13, QWP 170 and polarizer 160 are formed on opposite surfaces of curved substrate 152. In an alternate embodiment of the preset invention, the lens substrate is made of transitional material such as a photochromic material. Light-responsive photochromic lenses can be made of many different materials including glass, plastic or polycarbonate resins. There are many types of photochromic molecules in various classes, including: triarylmethanes, stilbenes, azastilbenes, nitrones, fulgides, spiropyrans, naphthopyrans, spiro-oxazines, quinines, and others.

### Materials and Structure of Elongated Structures

Conventional wire grid polarizers are formed using a parallel arrangement of thin aluminum strips that extend across the polarizer surface, generally using a glass substrate. Embodiments of the present invention can also use aluminum or other metals for elongated structures 256 (FIG. 6). Some of the other metals that have been used for wire grid polarizers include gold, platinum, chromium, nickel, copper, silver, and tungsten, for example, and other metals such as rhodium may also offer advantages. Metals such as these have complex indices of refraction, as defined earlier, which makes these materials particularly well-suited for use as elongated structures in wire grid polarizers.

Elongated structures 256 (FIG. 6) for the linear polarizer can alternately be formed from a combination of materials, wherein at least one of the materials has a complex index of refraction, as defined earlier. Elongated structures 258 (FIG. 8C) for the QWP are not formed from materials that exhibit a complex index of refraction, but are formed from materials having a predominantly real index of refraction. Both types of structures can be formed on the same lens substrate, as shown in FIG. 13, for example.

Embodiments of the present invention relax the requirements of conventional practice and provide a number of improvements for fabrication of viewing glasses. Conventional practice, as taught in U.S. Pat. No. 7,854,506 to Johnson et al. and entitled “Curved Lenses Configured to Decode Three-Dimensional Content on Television and Computer Screens” requires that the polarization axis be either at horizontal or 45 degrees from horizontal. It is believed that this restriction is imposed because of the difficulty of maintaining an accurate polarization axis when the stretched polymer material is curved, either by itself or applied over a curved substrate. The Applicants have found, however, that this restriction is unnecessary, particularly where the resulting polarization axis can be adequately calculated.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

1. An article of eyewear for viewing a 3D display, the article having at least one lens wherein the at least one lens comprises:
a substrate lens material that is transparent to visible light and has a curved surface; and
a circular polarizer formed on the substrate lens material, wherein the circular polarizer comprises:
(i) a linear polarizer having a polarization axis; and
(ii) a quarter wave plate having a retardation axis that is inclined at substantially 45 degrees from the polarization axis along the curved surface,
wherein either or both of the linear polarizer and the quarter wave plate are formed as sub-wavelength elongated structure devices.

2. The article of claim 1 wherein orientation of the polarization axis varies over the surface of the substrate lens material and wherein orientation of the retardation axis varies correspondingly to maintain the angular inclination at substantially 45 degrees over the curved surface.

3. The article of claim 1 wherein the circular polarizer is sandwiched between two lamination layers.

4. The article of claim 1 further comprising a coating on the lens surface.

5. The article of claim 1 wherein at least a portion of the circular polarizer is formed on the convex side of the curved surface.

6. The article of claim 1 wherein at least a portion of the circular polarizer is formed on the concave side of the curved surface.

7. The article of claim 1 further comprising a photochromic material in the lens.

8. The article of claim 1 wherein one or both of the linear polarizer and the quarter wave plate are formed directly on the substrate surface.

9. The article of claim 1 wherein the at least one lens is optically corrected.

10. The article of claim 1 wherein both of the linear polarizer and the quarter wave plate are formed as sub-wavelength elongated structure devices.

11. An article of circularly polarized eyewear comprising:
a curved substrate;
a first set of sub-wavelength elongated structures formed on the curved substrate from a first material that has a first index of refraction wherein the ratio between the imaginary and real components of the first index of refraction equals or exceeds 0.2; and
a second set of sub-wavelength elongated structures formed on the curved substrate from a second material that has a second index of refraction wherein the ratio between the imaginary and real components of the second index of refraction is less than 0.2.

12. The article of claim 11 wherein adjacent elongated structures of the first set of sub-wavelength elongated structures are piecewise parallel along the curved surface.

13. The article of claim 11 further comprising a photochromic material in the substrate.

14. The article of claim 1 wherein the substrate forms a lens that is optically corrected.

15. An article of circularly polarized eyewear for viewing a 3D display having at least one lens, wherein the at least one lens comprises:
a substrate lens material that is transparent to visible light and has a curved surface; and
a circular polarizer formed as a cholesteric polarizer.
